(19) United States
(12) Patent Application Publication
(10) Pub. No.: US 2014/0375599 A1
(43) Pub. Date: Dec. 25, 2014

(54) TOUCH INPUT SYSTEM AND METHOD

(71) Applicant: WALTOP INTERNATIONAL CORP., Hsinchu City (TW)

(72) Inventors: CHUNG FUU MAO, Hsinchu City (TW); CHIA JUI YEH, Hsinchu City (TW); CHENGPENG KUAN, Hsinchu City (TW)

(73) Assignee: WALTOP INTERNATIONAL CORP., Hsinchu City (TW)

(21) Appl. No.: 14/109,335

(22) Filed: Dec. 17, 2013

(30) Foreign Application Priority Data
Jun. 19, 2013 (TW) 102211445

(51) Int. Cl. G06F 3/0354; G06F 3/044

(52) U.S. Cl. CPC G06F 3/03545; G06F 3/044
USPC 345/174

(57) ABSTRACT

A touch input system provided in the present invention includes a touch panel, a conducting coil, and an electromagnetic pen. The touch panel has a sensing area and a marginal area. The conducting coil is disposed on the touch panel. The conducting coil has a circuit with a plurality of turns wound by a conductive wire, and the circuit with the plurality of turns is located at the marginal area and surrounds the sensing area. The electromagnetic pen is utilized to transmit an electromagnetic signal to the conducting coil for performing a detection of a touch pressure. The electromagnetic pen includes a pen tip which is utilized to contact the sensing area for performing a detection of a touch position, and the pen tip is a conductor. A touch input method is further provided in the present invention.

### TECHNICAL FIELD OF THE INVENTION

The present invention relates to a touch input system and method, and especially to a touch input system and method being capable of simultaneously sensing a touch position and a touch pressure.

### BACKGROUND OF THE INVENTION

Touch technology can be divided into the following types: resistive, capacitive surface acoustic wave, optics, and the like according to sensing principles thereof. With convenience of usage and a demand for multi-touch, the capacitive touch technology which inputs by fingers has become the mainstream of current electronic products.

A capacitive touch panel is a substrate on which transparent electrode patterns are coated. The substrate is not limited to solid or flexible material. When a finger is closes to or touches the touch panel, a coupling capacitor is formed between the finger and the transparent electrode patterns because the finger is a conductor and has static electricity. Meanwhile, the capacitance of the electrode positioned at a touch point on the touch panel will change, thus making the voltage or current on the electrode change. And then by comparing the voltage difference between the electrode and adjacent electrodes, the position of the touch point can be calculated.

However, although the touch input by the fingers is convenient, it is obviously difficult to achieve the following requirements of depicting lines with various thicknesses on a touchscreen, or touch recognition for fine locations by the fingers. Therefore, in order to increase the accuracy of the touch, a solution by using a stylus pen has been proposed. However, the principle of the conventional capacitive stylus pens is mostly to dispose a conductive plastic or conductive rubber pen tip on an end of a metal tube of the pen. Although it can achieve a more accurate input relative to the finger input, the capacitive stylus pen can not draw lines with various thicknesses on the screen corresponding to the force that one exerts to the pen, still having the shortcoming for the usage.

### SUMMARY OF THE INVENTION

Accordingly, an objective of the present invention is to provide a touch input system, which is capable of performing a touch input via an electromagnetic pen with a conductive pen tip on a touch panel that has a conducting coil wound around it. Then a high degree of accuracy for the touch can be achieved, and the shown line thicknesses can correspond to the force exerted to the pen.

Another objective of the present invention is to provide a touch input method, which provides a conductor to the pen tip of the electromagnetic pen and disposes the conducting coil onto the touch panel, so that the accuracy of the touch can be significantly improved, and the line thicknesses correspond to the force exerted to the pen.

To achieve the foregoing objectives, according to an aspect of the present invention, the touch input system provided in the present invention includes a touch panel, a conducting coil, and an electromagnetic pen. The touch panel has a sensing area and a marginal area. The conducting coil is disposed on the touch panel. The conducting coil has a circuit with a plurality of turns wound by a conductive wire, and the circuit with the plurality of turns is located at the marginal area and surrounds the sensing area. The electromagnetic pen is utilized to transmit an electromagnetic signal to the conducting coil for performing a detection of a touch pressure. The electromagnetic pen includes a pen tip which is utilized to contact the sensing area for performing a detection of a touch position, and the pen tip is a conductor. Meanwhile, the electromagnetic pen has a plurality of buttons and a pressure sensing structure of the pen tip, and thus an oscillation frequency of an internal circuit can vary with the force that an user exerts to the electromagnetic pen during writing. In other embodiments, the conducting coil can be disposed below the sensing area of the touch panel.

In one preferred embodiment, the touch panel includes a capacitive touch panel. Moreover, the conductive wire is made of transparent conductive material, or made of copper, silver, gold, or aluminum.

In one preferred embodiment, the turns of the circuit is between 3 and 10 turns. In the embodiment, the circuit with the plurality of turns has an identical spacing therebetween. In other embodiments, the circuit with the plurality of turns has a spacing therebetween being gradually larger or smaller along a direction away from the sensing area.

In one preferred embodiment, the touch input system further includes an microcontroller. The microcontroller is electrically coupled to the conducting coil. The microcontroller controls the conducting coil to transmit an electromagnetic energy to the electromagnetic pen, and the microcontroller switches the conducting coil to receive the electromagnetic signal transmitted from the electromagnetic pen. Furthermore, the electromagnetic pen is a no-battery electromagnetic pen.

To achieve the foregoing objectives, according to an aspect of the present invention, the touch input method provided in the present invention is used for sensing a position and a pressure of an electromagnetic pen on a touch screen. The touch input system includes the steps of: providing a touch panel having a sensing area and a marginal area; disposing a conducting coil on the marginal area of the touch panel, the conducting coil having a circuit with a plurality of turns wound by a conductive wire, the circuit with the plurality of turns surrounding the sensing area; providing a conductor to a pen tip of the electromagnetic pen; contacting the sensing area of the touch panel by the pen tip; detecting a touch position on the sensing area by the touch panel; and transmitting an electromagnetic signal to the conducting coil by the electromagnetic pen for generating a pressure sensitive signal. In other embodiments, the conducting coil can be disposed below the sensing area of the touch panel.

In one preferred embodiment, the step of generating the pressure sensitive signal specifically includes: emitting a frequency-shift signal from the electromagnetic pen; receiving the frequency-shift signal by the conducting coil; providing a microprocessor to receive and process the frequency-shift signal; and generating the pressure sensitive signal according to the frequency-shift signal by the microprocessor. More specifically, the step of the microprocessor processing the frequency-shift signal includes: comparing a difference between the frequency-shift signal and a base frequency; and performing an analog-to-digital conversion for the difference in order to obtain a digital value. Moreover, a scale of the digital value indicates magnitude of a force exerted to the electromagnetic pen.

In one preferred embodiment, before the step of contacting the sensing area of the touch panel by the pen tip, the touch input method further includes: transmitting a baseband signal to the conducting coil by the electromagnetic pen for generating a hovering signal. Among them, the step of generating the hovering signal specifically includes: emitting a baseband signal from the electromagnetic pen; receiving the baseband signal by the conducting coil; providing a microprocessor to receive and process the baseband signal; and generating the hovering signal based on the baseband signal by the microprocessor.

Similarly, in one preferred embodiment, the circuit with the plurality of turns has an identical spacing therebetween. In other embodiments, the circuit with the plurality of turns has a spacing therebetween being gradually larger or smaller along a direction away from the sensing area.

In comparison with the prior art, the present invention employs the electromagnetic pen with the conductive pen tip to contact the capacitive touch panel, thereby achieving the high degree of accuracy for the touch. In addition, by receiving the electromagnetic signal of the electromagnetic pen via the conducting coil that is wound around the touch panel, and by calculating the frequency of the electromagnetic signal, it can be regarded as grades of the pressure sensing of the pen tip, thereby precisely achieving the objective of detecting the force exerted to the pen.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a functional block diagram illustrating a touch input system according to a first embodiment of the present invention;

FIGS. 2A to 2C are schematic drawings illustrating a conducting coil according to embodiments of the present invention;

FIG. 3 is a functional block diagram illustrating another mode in the first embodiment of the present invention;

FIG. 4 is a functional block diagram illustrating still another mode in the first embodiment of the present invention;

FIG. 5 is a functional block diagram illustrating yet another mode in the first embodiment of the present invention;

FIG. 6 is a functional block diagram illustrating a touch input system according to a second embodiment of the present invention;

FIG. 7 is a functional block diagram illustrating another mode in the second embodiment of the present invention;

FIG. 8 is a flow chart illustrating a touch input method according a preferred embodiment of the present invention;

FIG. 9 depicts a specific flow chart illustrating step S50 and step S60 of FIG. 8;

FIG. 10 depicts a specific flow chart illustrating step S50 and step S60 according to another mode;

FIG. 11 depicts a specific flow chart illustrating step S50 and step S60 according to still another mode; and

FIG. 12 depicts a specific flow chart illustrating step S50 and step S60 according to yet another mode.

### DETAILED DESCRIPTION OF THE INVENTION

The present invention will now be described in detail with reference to a few preferred embodiments thereof as illustrated in the accompanying drawings. The same reference numerals refer to the same parts or like parts throughout the various figures.

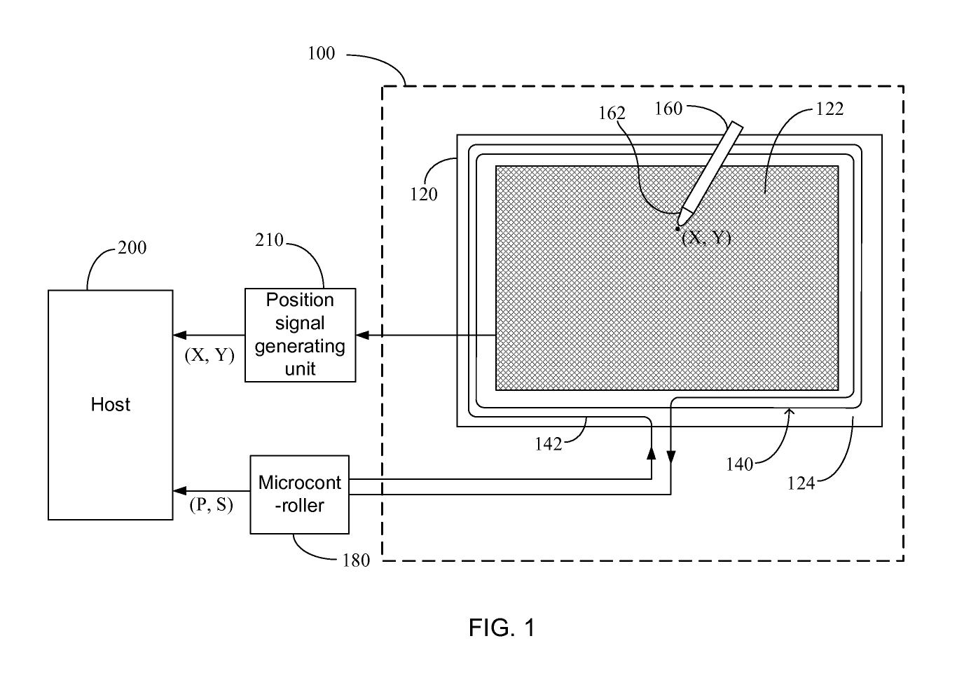

Referring to FIG. 1, FIG. 1 is a functional block diagram illustrating a touch input system according to a first embodiment of the present invention. In order to explain clearly, the touch input system 100 of the embodiment is shown as dashed lines. The touch input system 100 includes a touch panel 120, a conducting coil 140, and an electromagnetic pen 160. The touch panel has a sensing area 122 and a marginal area 124. In the preferred embodiment, the touch panel 120 is a capacitive touch panel, and has transparent metal electrode patterns (not shown) being coated on the sensing area 12. The material thereof is preferably Indium Tin Oxide (ITO), Indium Zinc Oxide (IZO), or carbon nanotubes.

As shown in FIG. 1, the conducting coil 140 is disposed on the touch panel 120. The conducting coil 140 has a circuit with a plurality of turns wound by a conductive wire 142, and the circuit with the plurality of turns is located at the marginal area 124 and surrounds the sensing area 122. Preferably, the conductive wire 142 is made of transparent conductive material. In the embodiment, the transparent conductive material includes the Indium Tin Oxide (ITO), the Indium Zinc Oxide (IZO), or the carbon nanotubes. It is worth mentioning that the conductive wire 142 and the metal electrode patterns can be formed at the same time during manufacture processes of the capacitive touch panel, without additional manufacture processes so as to reduce costs. Accordingly, the material of the conductive wire 142 is the same as that of the metal electrode patterns, and they are positioned on a same substrate. In consideration of internal resistance of the conducting coil 140, the conductive wire 142 of the present invention also can be made of a material being different from that of the metal electrode patterns. For example, the conductive wire 142 is made of copper, silver, gold, or aluminum.

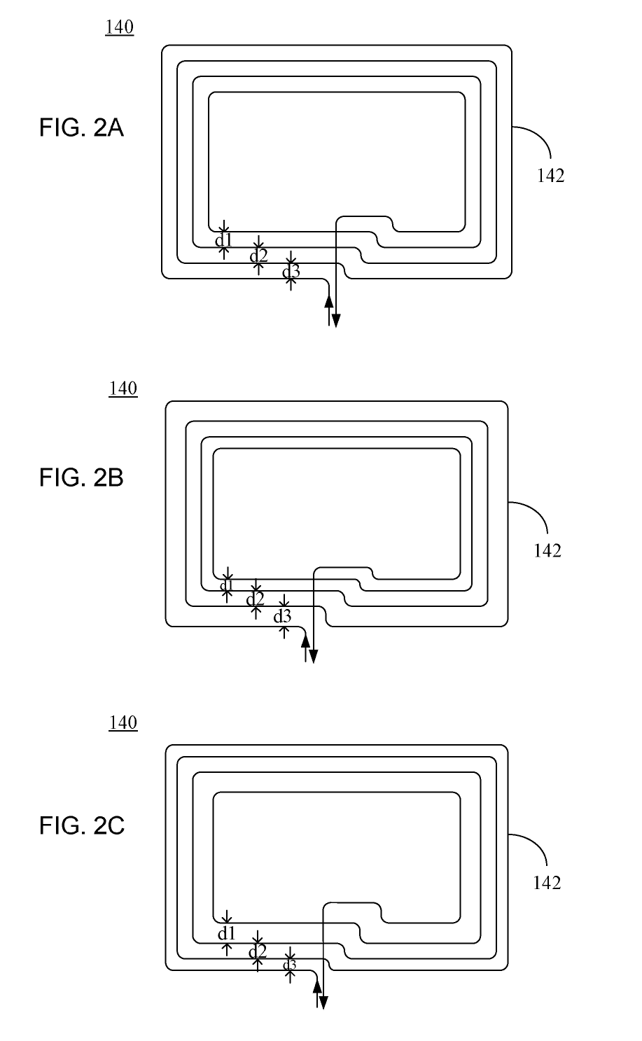

What follows is a detail of the specific structure with respect to the conducting coil 140. Referring to FIGS. 2A to 2C, FIGS. 2A to 2C are schematic drawings respectively illustrating the conducting coil 140 according to embodiments of the present invention. The turns of the circuit of the conducting coil 140 is between 3 and 10 turns. In the embodiments, the conductive wire 142 is wound around in 4 turns; however, a number of the turns is not limited in the present invention.

As shown in FIG. 2A, in the first embodiment, the circuit with the plurality of turns of the conductive wire 142 has an identical spacing therebetween; that is, Spacing d1=Spacing d2=Spacing d3. As shown in FIG. 2B, in the second embodiment, the circuit with the plurality of turns of the conductive wire 142 has the spacing which are gradually larger along a direction away from the sensing area 122 (as shown in FIG. 1); that is, Spacing d1<Spacing d2<Spacing d3. As shown in FIG. 2C, in the third embodiment, the circuit with the plurality of turns of the conductive wire 142 has the spacing which are gradually smaller along the direction away from the sensing area 122 (as shown in FIG. 1); that is, Spacing d1>Spacing d2>Spacing d3. The spacing of the circuit with the plurality of turns can be appropriately arranged according to a size and a shape of the sensing area 122, so that electromagnetic energy generated from the conductive wire 142 can be uniformly distributed on the sensing area 122.

In other embodiments, the conducting coil 140 can be disposed below the sensing area 122 of the touch panel 120; that is, the conductive wire 142 can be coated on an opposite side of the substrate where the metal electrode patterns are located, or can be coated on an additional glass substrate which is provided below the substrate, and the conductive wire 142 is coated on the glass substrate.

Referring to FIG. 1 again, the electromagnetic pen 160 includes a pen tip 162, which is utilized to contact the sensing area 122 for performing a detection of a touch position, and the pen tip 162 is a conductor. Preferably, the material of the conductor is metals, conductive plastics, conductive rubber, and so on. The pen tip 162 of the electromagnetic pen 160 is utilized to contact the above-mentioned capacitive touch panel, thereby achieving the high degree of accuracy for the touch. Furthermore, there is a coupling capacitor formed between the conductive pen tip 162 of the electromagnetic pen 160 and the transparent conductive material on the sensing area 122 such that electric currents around the sensing area 122 are changed, and then horizontal and vertical coordinates (X, Y) of the touch point can be calculated by an external position signal generating unit 210 and then be sent to an external host 200 (such as a computer). On the other hand, the electromagnetic pen 160 can transmit an electromagnetic signal (not shown) to the conducting coil 140 for performing a detection of a touch pressure.

Specifically, the electromagnetic pen 160 can be an electromagnetic pen with a battery (otherwise known as active electromagnetic pen) or a no-battery electromagnetic pen (otherwise known as passive electromagnetic pen). The no-battery electromagnetic pen is illustrated in the embodiment. As shown in FIG. 1, the embodiment provides a microcontroller 180, which is electrically coupled to the conducting coil 140. The microcontroller controls the conducting coil 140 to transmit an electromagnetic energy (not shown) to the electromagnetic pen 160. After a coil (not shown) within the electromagnetic pen 160 receives the electromagnetic energy, the coil is capable of transmitting the corresponding electromagnetic signal. Subsequently, the microcontroller 180 switches the conducting coil 180 to receive the electromagnetic signal transmitted from the electromagnetic pen 160. Then the microcontroller 180 computes the pressure of the electromagnetic pen 160 on the touch panel 120 according to the electromagnetic signal, then generating a pressure sensitive signal P to the host 200. The pressure sensitive signal P herein represents a scale value of the applied pressure of the pen tip. Moreover, the electromagnetic pen 160 may be provided with a plurality of additional buttons or switches (not shown) for users to switch, and the electromagnetic pen 160 can send out the corresponding electromagnetic signal according to different statuses of the switches. Then the microcontroller 180 can compute a corresponding switch signal S, which the switch signal S represents a value of the statuses of the switches. The switch signal S can be utilized to add additional functions, such as wiper, etc, for the touch input.

It is worth mentioning that data interfaces between the host 200 and the position signal generating unit 210 or the microcontroller 180 can be a USB, I2C, UART, SPI, Bluetooth, RF, and so on. However, the present invention is not limited thereto.

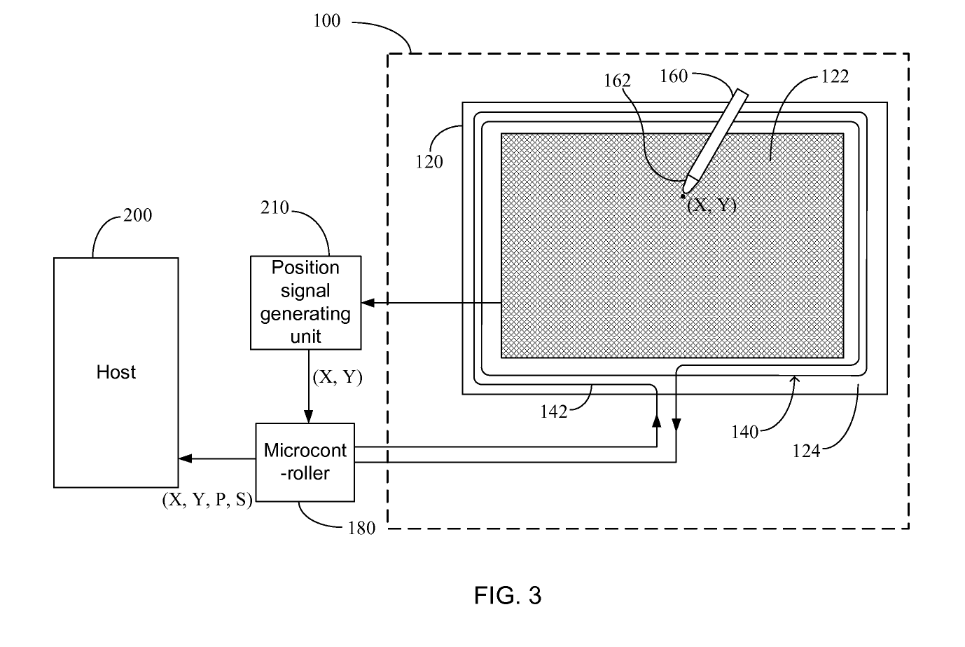

Referring to FIG. 3, FIG. 3 is a functional block diagram illustrating another mode in the first embodiment of the present invention. One difference from the above mention is that the horizontal and vertical coordinates (X, Y) calculated by the position signal generating unit 210 is transmitted to the microcontroller 180, and then the horizontal and vertical coordinates (X, Y), the computed pressure sensitive signal P, and the switch signal S are transmitted to the host 200 by the microcontroller 180. Similarly, the data interface between the host 200 and the microcontroller 180 can be a USB, I2C, UART, SPI, Bluetooth, RF, and so on. However, the present invention is not limited thereto.

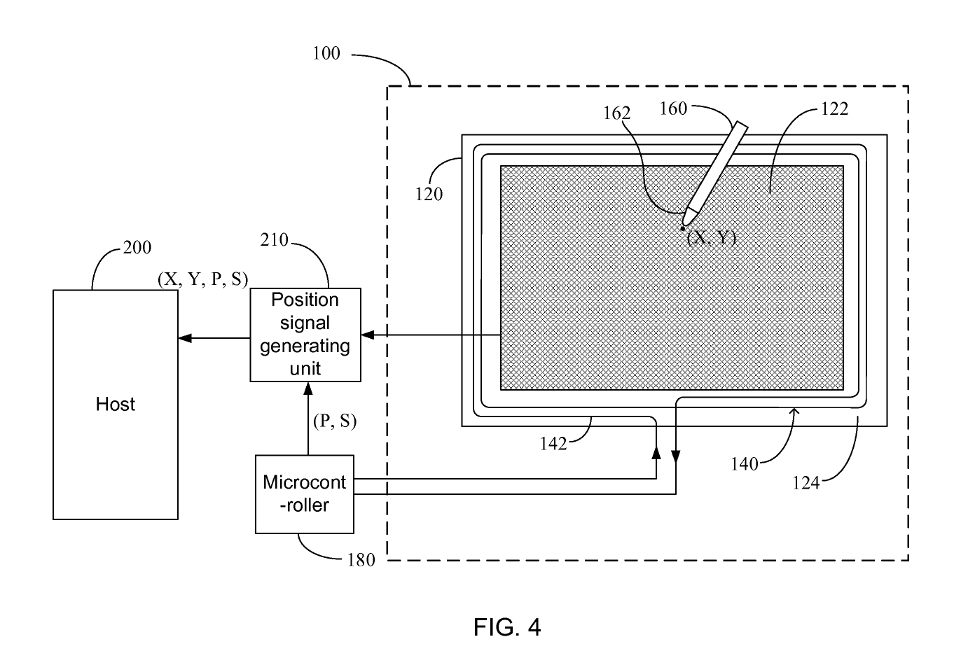

Referring to FIG. 4, FIG. 4 is a functional block diagram illustrating still another mode in the first embodiment of the present invention. One difference from the above mention is that the pressure sensitive signal P and the switch signal S computed by the microcontroller 180 are transmitted to the position signal generating unit 210, and then the horizontal and vertical coordinates (X, Y), the computed pressure sensitive signal P, and the switch signal S are transmitted to the host 200 by the position signal Generating unit 210. Similarly, the data interface between the host 200 and the position signal generating unit 210 can be a USB, I2C, UART, SPI, Bluetooth, RF, and so on. However, the present invention is not limited thereto.

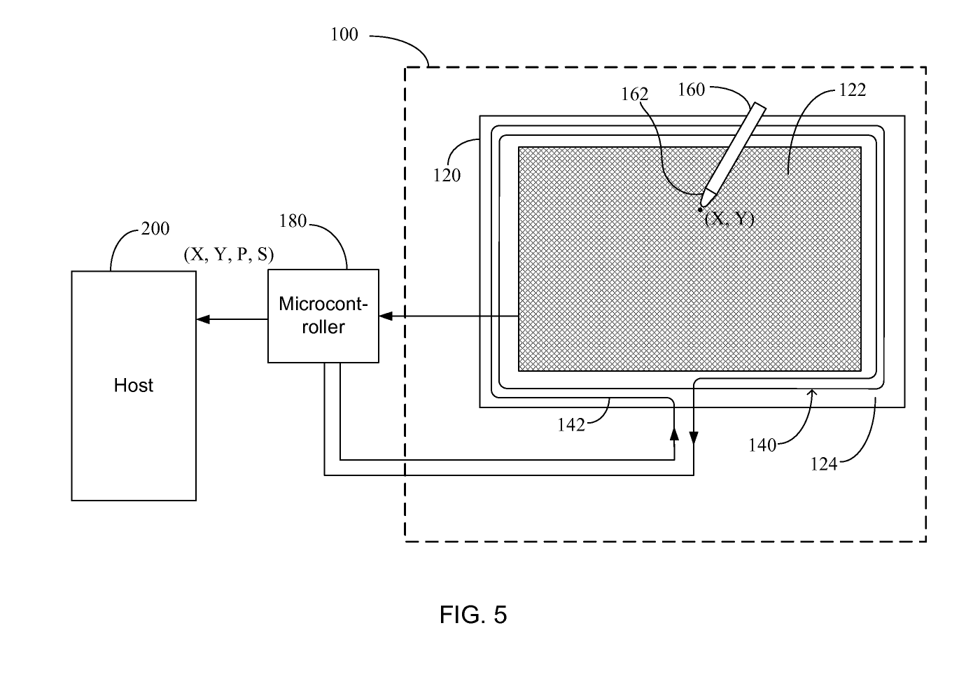

Referring to FIG. 5, FIG. 5 is a functional block diagram illustrating yet another mode in the first embodiment of the present invention. One difference from the above mention is that the microcontroller 180 of the embodiment, which is electrically coupled to the touch panel 120, has the function of computing the horizontal and vertical coordinates (X, Y) of the touch point, and the function of computing the pressure sensitive signal P and the switch signal S at the same time. Then the horizontal and vertical coordinates (X, Y), the computed pressure sensitive signal P, and the switch signal S are transmitted to the host 200 by the microcontroller 180. Similarly, the data interface between the host 200 and the microcontroller 180 can be a USB, I2C, UART, SPI, Bluetooth, RF, and so on. However, the present invention is not limited thereto.

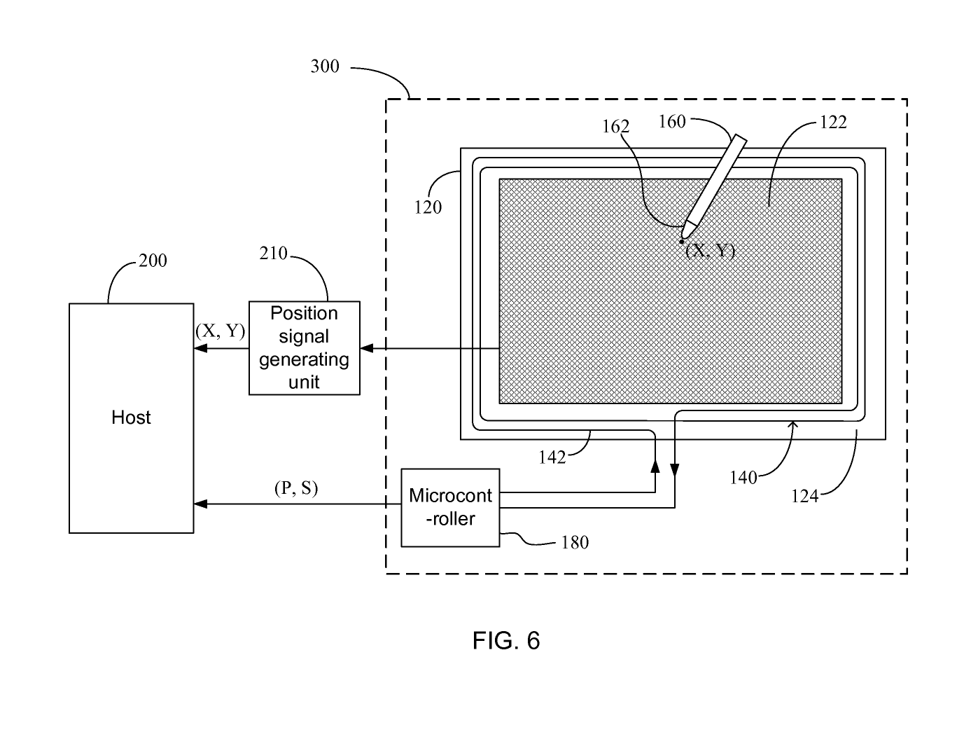

Referring to FIG. 6, FIG. 6 is a functional block diagram illustrating a touch input system according to a second embodiment of the present invention. The touch input system of the second preferred embodiment is designated at 300. The touch input system 300 includes a touch panel 120, a conducting coil 140, and an electromagnetic pen 160, and a microcontroller 180. The differences between the touch input system 300 of the second preferred embodiment and the touch input system 100 of the first preferred embodiment are that the touch input system 300 of the second preferred embodiment comprises the above-mentioned microcontroller 180. The descriptions of these elements have been explained as above mention, so we need not go into detail herein.

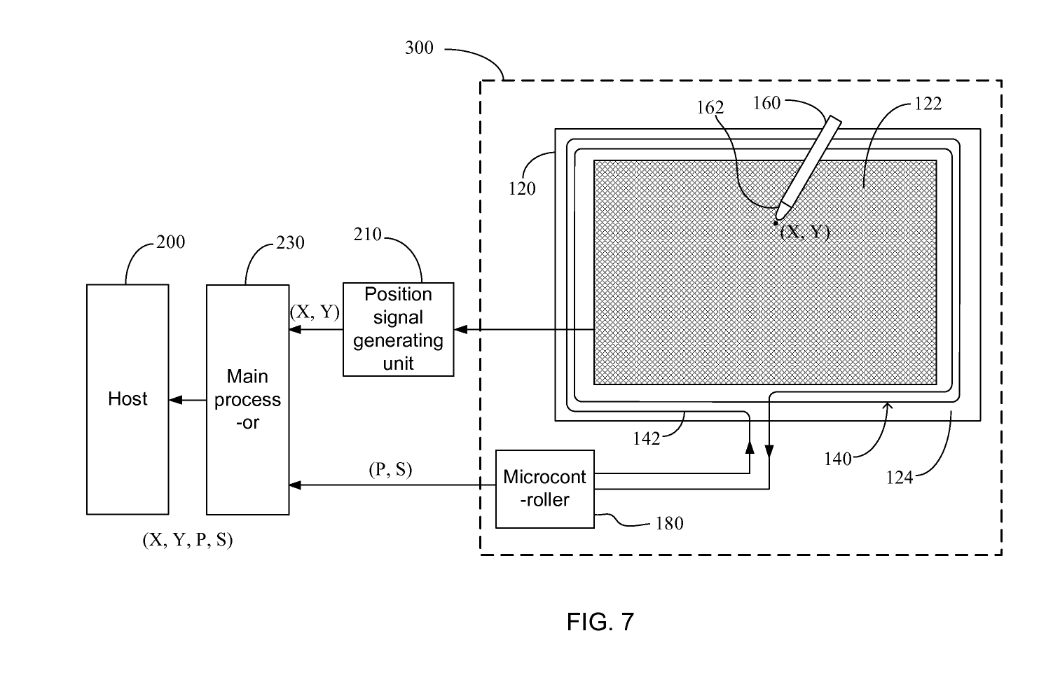

Referring to FIG. 7, FIG. 7 is a functional block diagram illustrating another mode in the second embodiment of the present invention. One difference from the above mention is that the position signal generating unit 210 and the microcontroller 180 are electrically coupled to a main processor 230. The main processor 230 may include an analog/digital converter circuit, an amplifier circuit, a filter circuit, a frequency counter circuit, etc, which can perform further computations for the horizontal and vertical coordinates (X, Y), the pressure sensitive signal P, and the switch signal S. For example, the functions of a ghost point determination for the horizontal and vertical coordinates (X, Y), a scale value grading for the pressure sensitive signal P, a palm rejection, and so on can be executed, and they are transmitted to the host 200 after these computations. Similarly, the data interface between the host 200 and the main processor 230 can be a USB, I2C, UART, SPI, Bluetooth, RF, and so on. However, the present invention is not limited thereto.

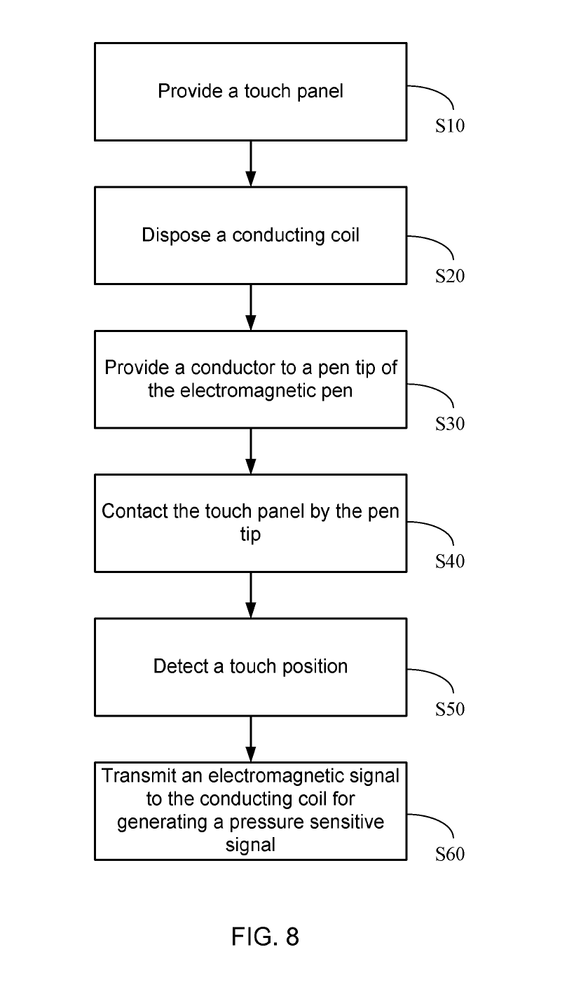

What follows is a detail of a touch input method adopting the touch input system 100 of the embodiment. Referring to FIG. 1 and FIG. 8, FIG. 8 is a flow chart illustrating a touch input method according a preferred embodiment of the present invention. The touch input method of the embodiment is used for sensing a position and a pressure of an electromagnetic pen 160 on a touch screen, and the descriptions of the following elements have been explained as above mention, so we need not go into detail herein.

The touch input method begins with step S10. At step S10, a touch panel 120 having a sensing area 122 and a marginal area 124 is provided, and then execution resumes at step S20. In the embodiment, the touch panel 120 is preferably a capacitive touch panel.

At step S20, a conducting coil 140 is disposed on the marginal area 124 of the touch panel 120, and then execution resumes at step S30. The conducting coil 140 has a circuit with a plurality of turns wound by a conductive wire 142, and the circuit with the plurality of turns surrounds the sensing area 122. In the embodiment, the conductive wire 142 is made of transparent conductive material, which includes Indium Tin Oxide (ITO) or Indium Zinc Oxide (IZO). Moreover, the circuit with the plurality of turns is between 3 and 10 turns. As shown in FIG. 2A, the circuit with the plurality of turns has an identical spacing therebetween. In other embodiments, as shown in FIG. 2B, the circuit with the plurality of turns has a spacing therebetween being gradually larger along a direction away from the sensing area 122. Optionally, as shown in FIG. 2C, the circuit with the plurality of turns has a spacing therebetween being gradually smaller along a direction away from the sensing area 122.

Moreover, in other embodiments, step S20 may include to dispose a conducting coil 140 below the touch panel 120, wherein the conducting coil 140 has the circuit with a plurality of turns wound by the conductive wire 142, and then execution resumes at step S30. That is to say, the conductive wire 142 can be coated on an opposite side of the substrate where the metal electrode patterns are located, or can be coated on an additional glass substrate which is provided below the substrate, and the conductive wire 142 is coated on the glass substrate.

At step S30, a pen tip 162 of the electromagnetic pen 160 is provided with a conductor, and then execution resumes at step S40. Preferably, the material of the conductor is metals, conductive plastics, conductive rubber, and so on.

At step S40, the pen tip 162 contacts the sensing area 122 of the touch panel 120, and then execution resumes at step S50.

At step S50, the touch panel 120 detects a touch position (i.e., the horizontal and vertical coordinates (X, Y)) on the sensing area 122, and then execution resumes at step S60.

At step S60, the electromagnetic pen 160 transmits an electromagnetic signal to the conducting coil 140 for generating a pressure sensitive signal. It is worth mentioning that the touch input method of the present invention is not limited to the execution order of the above-mentioned steps. For example, after executing step S40, step S50 and step S60 can be simultaneously executed. Optionally, firstly, step S60 can be executed, and then execution resumes at step S50.

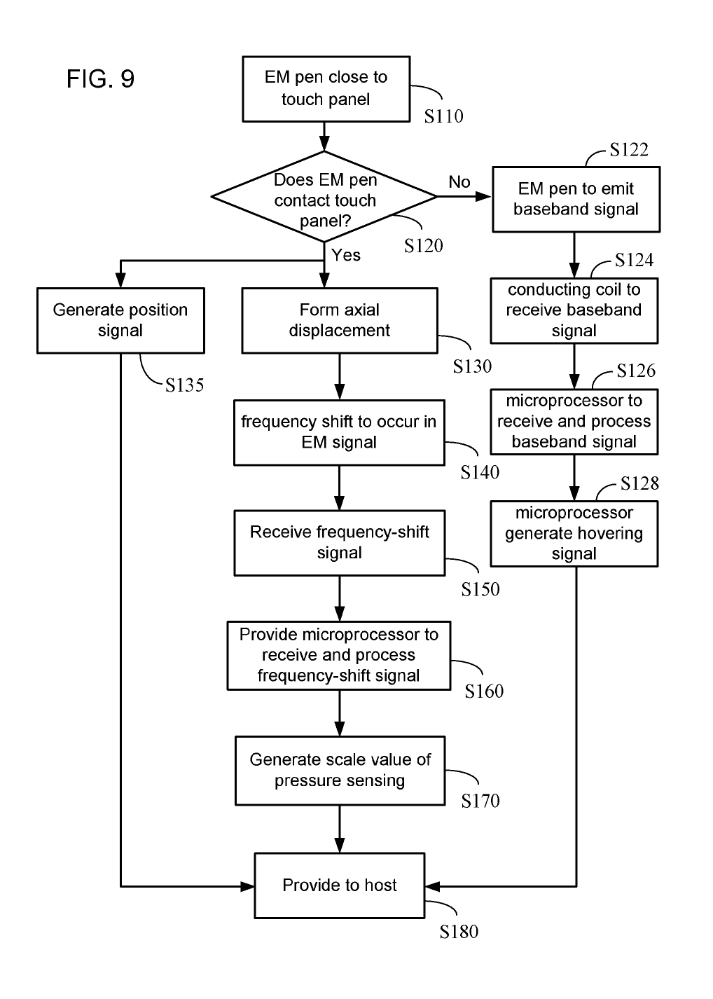

The specific steps of detecting the touch position and generating the pressure sensitive signal at step S50 and step S60 will be explained in detail in the following. Referring to FIG. 1 and FIG. 9, FIG. 9 depicts a specific flow chart illustrating step S50 and step S60 of FIG. 8.

As shown in FIG. 9, before step S40, that is, before the pen tip 162 contacts the sensing area 122 of the touch panel 120, the touch input method further includes step S110. That is, the electromagnetic (EM) pen 160 is close to the touch panel 120, and then execution resumes at step S120.

At step S120, it is determined whether the electromagnetic pen 160 contacts the touch panel 120. If so, then execution resumes at step S130 and step S135. If no, then the electromagnetic pen 160 transmits a baseband signal to the conducting coil 140 for generating a hovering signal. That is, step S122 to step 128 are executed. Specifically, the steps of generating the hovering signal begin with step S122. At step S122, the electromagnetic pen 160 emits a baseband signal, and then execution resumes at step S124. At step S124, the conducting coil 140 receives the baseband signal, and then execution resumes at step S126. At step S126, a microprocessor 180 is provided to receive and process the baseband signal, and then execution resumes at step S128. At step S128, the microprocessor 180 generates the hovering signal based on the baseband signal, and then execution resumes at step S180; that is, the hovering signal is provided to the host 200.

At step S135, a position signal is generated, and then execution resumes at step S180; that is, the position signal is provided to the host 200. Specifically, there is a coupling capacitor formed between the conductive pen tip 162 of the electromagnetic pen 160 and the transparent conductive material on the sensing area 122such that electric currents around the sensing area 122 are changed, and then the horizontal and vertical coordinates (X, Y) of the touch point (i.e., the above-mentioned position signal) can be calculated by an external position signal generating unit 210 and then be sent to an external host 200.

At step S130, the pen tip 162 of the electromagnetic pen 160 is given a force, and thus an axial displacement is formed, and then execution resumes at step S140. At step S140, since the pen tip 162 of the electromagnetic pen 160 has the displacement, a phenomenon of frequency shift occurs in the electromagnetic signal emitted from the electromagnetic pen 160. That is, a frequency-shift signal is emitted, and then execution resumes at step S150. The frequency-shift signal herein is different from the baseband signal. At step S150, the conducting coil 140 receives the frequency-shift signal, and then execution resumes at step S160. At step S160, a microprocessor 180 is provided to receive and process the frequency-shift signal, and then execution resumes at step S170. At step S170, the microcontroller 180 generates the scale value of the pressure sensing based on the frequency shift. That is, the microprocessor 180 generates the pressure sensitive signal P according to the frequency-shift signal P, and then execution resumes at step S180; that is, the pressure sensitive signal P is provided to the host 200.

Among them, the step of the microprocessor 180 processing the frequency-shift signal includes: comparing a difference between the frequency-shift signal and a base frequency; and then performing an analog-to-digital conversion for the difference in order to obtain a digital value. The scale of the digital value indicates the magnitude of a force exerted to the electromagnetic pen. The digital value is preferably is between 0 and 1023, or 0 and 255. That is, the digital value can be utilized to divide the force exerted to the pen into 1024 grades or 256 grades, and be provided for the host 200 for determining the corresponding line thicknesses shown on the touch panel 120.

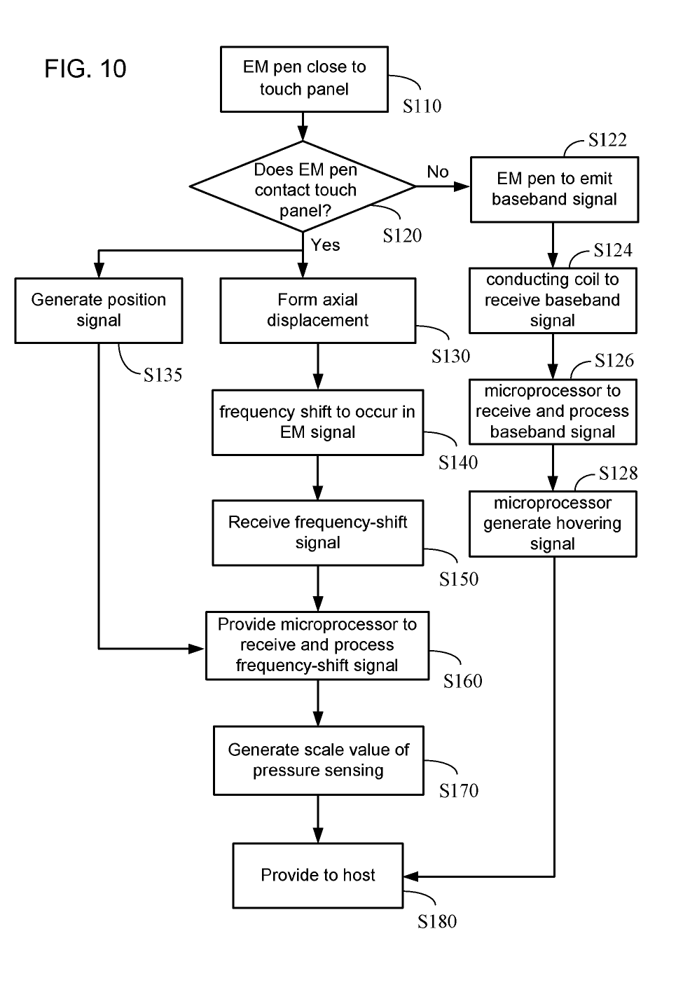

Referring to FIG. 3 and FIG. 10, FIG. 10 depicts a specific flow chart illustrating step S50 and step S60 according to another mode. One difference from the above-mentioned embodiment is that the position signal is generated at step S135, and then execution resumes at step S160. That is to say, after the position signal generating unit 210 calculates the horizontal and vertical coordinates (X, Y), the microcontroller 180 receives the horizontal and vertical coordinates (X, Y), and then the microcontroller 180 provides the horizontal and vertical coordinates (X, Y) and the pressure sensitive signal P to the host 200.

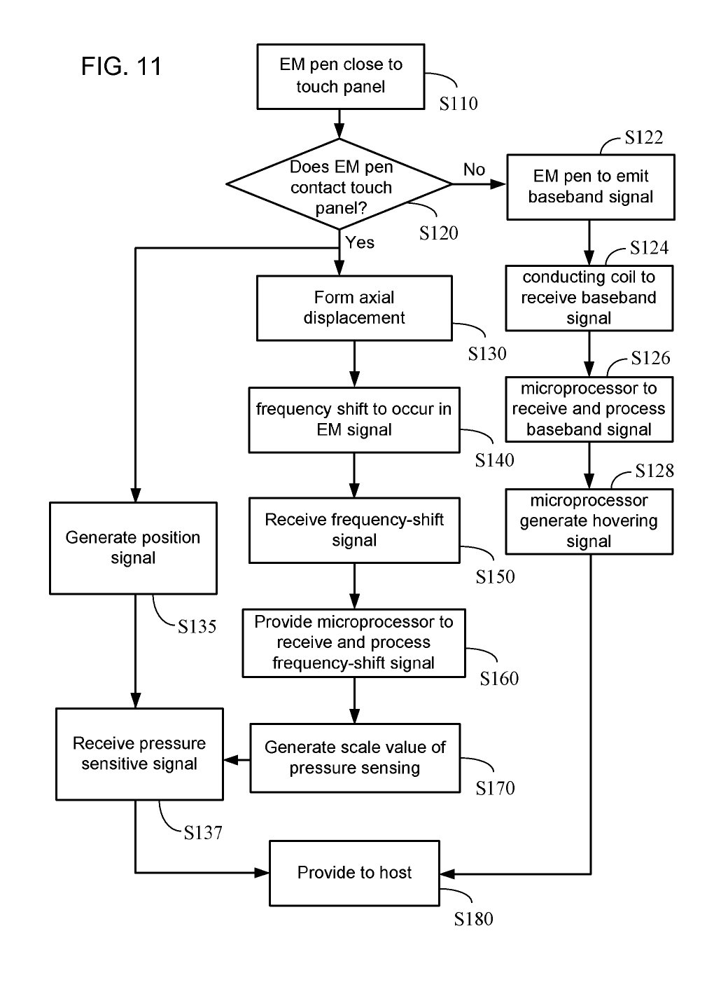

Referring to FIG. 4 and FIG. 11, FIG. 11 depicts a specific flow chart illustrating step S50 and step S60 according to still another mode. One difference from the above-mentioned embodiment is that the microcontroller 180 generates the scale value of the pressure sensing based on the frequency shift at step S170. That is, the microprocessor 180 generates the pressure sensitive signal P according to the frequency-shift signal P, and then execution resumes at step S137. At step S137, the position signal generating unit 210 receives the pressure sensitive signal P, and then execution resumes at step S180. That is to say, the position signal generating unit 210 provides the pressure sensitive signal P and the horizontal and vertical coordinates (X, Y) to the host 200.

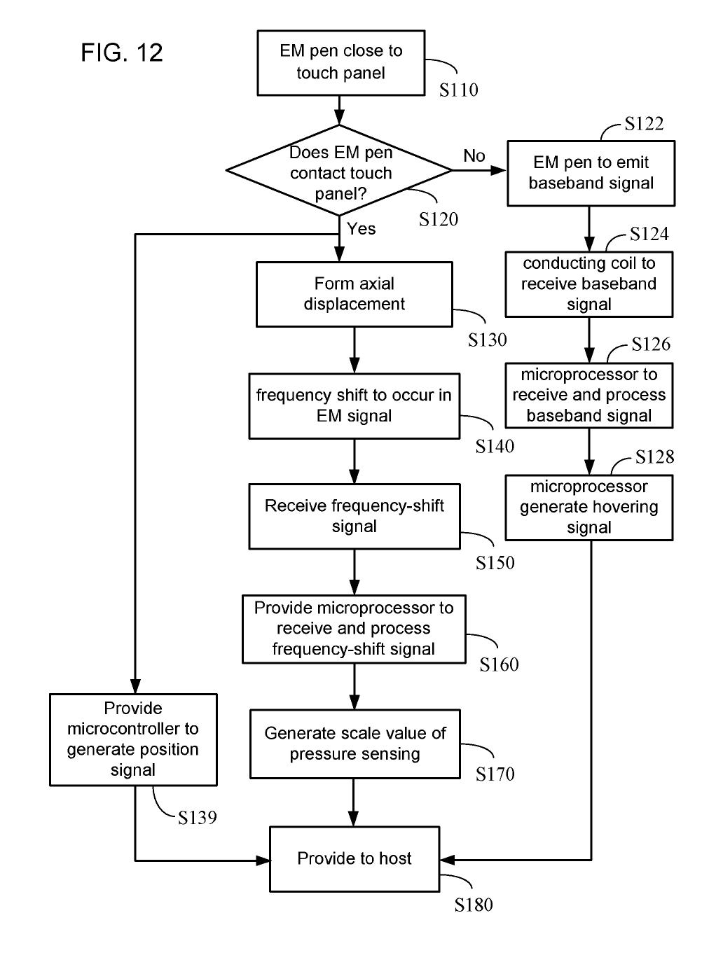

Referring to FIG. 5 and FIG. 12, FIG. 12 depicts a specific flow chart illustrating step S50 and step S60 according to yet another mode. One difference from the above-mentioned embodiment is that execution resumes at step S130 and step S139 after the determination at step S120 is yes. At step S139, the microcontroller 180 is provided to generate the position signal, and then execution resumes at step S180. That is to say, the microcontroller 180 can be utilized to generate the horizontal and vertical coordinates (X, Y), and generate the pressure sensitive signal P at the same time. Subsequently, the microcontroller 180 provides the horizontal and vertical coordinates (X, Y) and the pressure sensitive signal P to the host 200.

In summary, the present invention employs the electromagnetic pen 160 with the conductive pen tip 162 to contact the capacitive touch panel, thereby achieving the high degree of accuracy for the touch. In addition, the pressure sensitive signal can be generated via the electromagnetic pen 160 with the touch panel 120 that has a conducting coil 140 wound around it, thereby easily achieving the objective of detecting the force exerted to the pen.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A touch input system, comprising:
a touch panel having a sensing area and a marginal area;
a conducting coil disposed on the touch panel, the conducting coil having a circuit with a plurality of turns wound by a conductive wire, the circuit with the plurality of turns located at the marginal area and surrounding the sensing area; and
an electromagnetic pen utilized to transmit an electromagnetic signal to the conducting coil for sensing a touch pressure, wherein the electromagnetic pen comprises a pen tip utilized to contact the sensing area for the touch panel to sense a touch position, and the pen tip is a conductor.

2. The touch input system of claim 1, wherein the touch panel comprises a capacitive touch panel.

3. The touch input system of claim 2, wherein the conductive wire is made of transparent conductive material.

4. The touch input system of claim 1, wherein the conductive wire is made of copper, silver, gold, or aluminum.

5. The touch input system of claim 1, wherein the circuit with the plurality of turns is between 3 and 10 turns.

6. The touch input system of claim 5, wherein the circuit with the plurality of turns has an identical spacing therebetween.

7. The touch input system of claim 5, wherein the circuit with the plurality of turns has a spacing therebetween being gradually larger along a direction away from the sensing area.

8. The touch input system of claim 5, wherein the circuit with the plurality of turns has a spacing therebetween being gradually smaller along a direction away from the sensing area.

9. The touch input system of claim 1, further comprising:
a microcontroller electrically coupled to the conducting coil, the microcontroller controlling the conducting coil to transmit an electromagnetic energy to the electromagnetic pen, and the microcontroller switching the conducting coil to receive the electromagnetic signal transmitted from the electromagnetic pen, wherein the electromagnetic pen is a no-battery electromagnetic pen.

10. A touch input system, comprising:
a touch panel having a sensing area and a marginal area;
a conducting coil disposed below the sensing area of the touch panel, the conducting coil having a circuit with a plurality of turns wound by a conductive wire; and
an electromagnetic pen utilized to transmit an electromagnetic signal to the conducting coil for sensing a touch pressure, wherein the electromagnetic pen comprises a pen tip utilized to contact the sensing area for the touch panel to sense a touch position, and the pen tip is a conductor.

11. A touch input method for sensing a position and a pressure of an electromagnetic pen on a touch screen, the touch input system comprising the steps of:
providing a touch panel having a sensing area and a marginal area;
disposing a conducting coil on the marginal area of the touch panel, the conducting coil having a circuit with a plurality of turns wound by a conductive wire, the circuit with the plurality of turns surrounding the sensing area;
providing a conductor to a pen tip of the electromagnetic pen;
contacting the sensing area of the touch panel by the pen tip;
detecting a touch position on the sensing area by the touch panel; and
transmitting an electromagnetic signal to the conducting coil by the electromagnetic pen for generating a pressure sensitive signal.

12. The touch input method of claim 11, wherein the step of generating the pressure sensitive signal specifically comprises:
emitting a frequency-shift signal from the electromagnetic pen;
receiving the frequency-shift signal by the conducting coil;
providing a microprocessor to receive and process the frequency-shift signal; and
generating the pressure sensitive signal according to the frequency-shift signal by the microprocessor.

13. The touch input method of claim 12, wherein the step of the microprocessor processing the frequency-shift signal comprises:
comparing a difference between the frequency-shift signal and a base frequency; and
performing an analog-to-digital conversion for the difference in order to obtain a digital value.

14. The touch input method of claim 13, wherein a scale of the digital value indicates magnitude of a force exerted to the electromagnetic pen.

15. The touch input method of claim 11, wherein before the step of contacting the sensing area of the touch panel by the pen tip, the touch input method further comprises:
transmitting a baseband signal to the conducting coil by the electromagnetic pen for generating a hovering signal.

16. The touch input method of claim 15, wherein the step of generating the hovering signal specifically comprises:
emitting a baseband signal from the electromagnetic pen;
receiving the baseband signal by the conducting coil;
providing a microprocessor to receive and process the baseband signal; and
generating the hovering signal based on the baseband signal by the microprocessor.

17. The touch input method of claim 11, wherein the circuit with the plurality of turns has an identical spacing therebetween.

18. The touch input method of claim 11, wherein the circuit with the plurality of turns has a spacing therebetween being gradually larger along a direction away from the sensing area.

19. The touch input method of claim 11, wherein the circuit with the plurality of turns has a spacing therebetween being gradually smaller along a direction away from the sensing area.

20. A touch input method for sensing a position and a pressure of an electromagnetic pen on a touch screen, the touch input system comprising the steps of:
providing a touch panel having a sensing area and a marginal area;
disposing a conducting coil below the touch panel, the conducting coil having a circuit with a plurality of turns wound by a conductive wire;
providing a conductor to a pen tip of the electromagnetic pen;
contacting the sensing area of the touch panel by the pen tip;
detecting a touch position on the sensing area by the touch panel; and
transmitting an electromagnetic signal to the conducting coil by the electromagnetic pen for generating a pressure sensitive signal.
